(19) United States
(12) Patent Application Publication
(10) Pub. No.: US 2024/0376295 A1
(43) Pub. Date: Nov. 14, 2024

(54) TREATED INORGANIC PARTICLES FOR MODIFYING POLYMER CRYSTALLINITY

(71) Applicant: THE CHEMOURS COMPANY FC, LLC, WILMINGTON, DE (US)

(72) Inventors: PHILIPP MARTIN NIEDENZU, WILMINGTON, DE (US); TIAN ZHOU, NEWARK, DE (US); HERMAN LIM, TAOYUANCITY (TW); CHARLES DAVID MUSICK, WAVERLY, TN (US)

(73) Assignee: THE CHEMOURS COMPANY FC, LLC, WILMINGTON, DE (US)

(21) Appl. No.: 18/682,167

(22) PCT Filed: Aug. 5, 2022
(86) PCT No.: PCT/US2022/039560

§ 371 Date: Feb. 8, 2024

Related U.S. Application Data
(60) Provisional application No. 63/231,517, filed on Aug. 10, 2021.

(51) Int. Cl. C08K 9/04; C08K 3/22; C08L 23/06; C09C 1/36

(52) U.S. Cl. CPC C08K 9/04; C08K 3/22; C08L 23/06; C09C 1/3669; C01P 2004/61; C01P 2004/62; C01P 2006/12; C08K 2003/2241; C08K 2201/005; C08K 2201/006; C08L 2205/24; C08L 2207/062

(57) ABSTRACT

Described is a treated inorganic particle having an organic treatment layer, which can provide crystallization benefits to polymer resins. The treated inorganic particle has a mean particle size of about 0.1-10 μm, and the organic treatment layer is an alkali metal salt or alkaline earth metal salt of an acid; where the acid is an aromatic acid or organic diacid. The treated inorganic particles increase crystallization temperature, increase crystal formation rate, and/or decrease cooling time needed for the solidification of the polymer compared with pigmented resins using other inorganic particles.

### CROSS REFERENCE TO RELATED APPLICATIONS

This application is a national filing under 35 U.S.C. 371 of International Application No. PCT/US2022/039560 filed Aug. 5, 2022 and claims the benefit of priority of U.S. Provisional Application No. 63/231,517, filed Aug. 10, 2021, the disclosures of which are incorporated herein by reference in its entirety.

### FIELD OF THE INVENTION

Treated inorganic particles having an organic treatment layer are used to alter the crystalline behavior of polymer compositions and reduce polymer composite processing time.

### BACKGROUND OF THE INVENTION

Many thermoplastic polymers such as polypropylene form crystal structures as they cool. The presence of inorganic particles such as titania pigments affects the crystallization temperature and behavior of the crystalline polymer. The crystallinity behavior and rate of formation are noticeable, for example, by cooling curves on differential scanning calorimetry (DSC) outputs. In processing crystalline polymer products, it is often desirable to increase the rate of crystallization or crystallization temperature to reduce the cooling time of the polymer and thus increase productivity. It is further desirable to provide this benefit in the form of an inorganic particle, such that the crystalline effects can be achieved while also providing the pigmentary and opacity benefits of the inorganic particle.

Bhuiyan et al. demonstrates the crystallization behavior of isotactic polypropylene when titanium dioxide nanoparticles particles are added (Bhuiyan et al., “Structural, elastic and thermal properties of titanium dioxide filled isotactic polypropylene”, J Polym Res (2011), 18:1073-1079). With higher loadings of the nanoparticles, it is shown that the beta crystals can be shifted to alpha or gamma crystals. However, there is no suggestion for how to alter the crystalline behavior using larger particles, or using lower quantities of inorganic particles.

Stretched multilayer porous films of polypropylene polymer have been shown to have increased beta crystallization (40-95%) with the incorporation of beta-crystallization agents such as carboxylic acids and acid salts (Schmitz et al., US2017/0047567). Inorganic particles were added to induce pore formation during the stretching process, where vacuoles were formed at the site of the inorganic particles. However, there is no suggestion to reduce the beta crystallization or increase the crystallization temperature in these formulations.

### BRIEF SUMMARY OF THE INVENTION

The need exists for polymer formulations having accelerated crystal formation and for inorganic additives useful in polymer compositions to provide this benefit. The present invention provides inorganic particles that control polymer crystallization to increase crystallization temperature, increase crystal formation rate, and/or decrease cooling time needed for the solidification of the polymer. In some cases where traditional inorganic particles retard the crystallization of the neat resin, the inorganic particles of the present invention allow the resin to crystallize at rates equivalent to neat resin while also providing the opacity or pigmentation benefits of the inorganic particle.

The present invention relates to a treated inorganic particle comprising an inorganic particle having a surface and an organic treatment layer on the inorganic particle surface, where the treated inorganic particle has a mean particle size of about 0.1-10 μm and where the organic treatment layer is selected from alkali metal salt or alkaline earth metal salt of an acid; where the acid is an aromatic acid or organic diacid.

The present invention further relates to a polymer composition comprising a polymer and a treated inorganic particle, where the treated inorganic particle comprises an inorganic particle having a surface and an organic treatment layer on the inorganic particle surface, where the inorganic particle has a mean particle size of about 0.1-10 μm and where the organic treatment layer is selected from alkali metal salt or alkaline earth metal salt of an acid; where the acid is an aromatic acid or organic diacid; and where the polymer is polypropylene homopolymer or copolymer, polyethylene homopolymer or copolymer, polyester, or mixtures thereof.

### DETAILED DESCRIPTION OF THE INVENTION

Features of the embodiments of the present invention as described in the Detailed Description of the Invention can be combined in any manner.

In one aspect, the present invention relates to a treated inorganic particle comprising an inorganic particle having a surface and an organic treatment layer on the inorganic particle surface, where the treated inorganic particle has a mean particle size of about 0.1-10 μm and where the organic treatment layer is selected from alkali metal salt or alkaline earth metal salt of an acid; where the acid is an aromatic acid or organic diacid.

The term “mean particle size” is intended to mean the mathematical mean of a sample of particles having a particle size distribution. It can be measured in dilute aqueous dispersions with a particle size analyzer, such as Horiba LA-300 Particle Size Analyzer. The mean particle size of the treated inorganic particle is about 0.1-10 μm; in another aspect, the mean particle size of the treated inorganic particle is about 0.1-1 μm; in yet another aspect, the mean particle size of the treated inorganic particle is about 0.2-1 μm. The treated inorganic particles have a BET surface area of about 1-100 m²/g; in another aspect, the treated inorganic particles have a BET surface area of about 5-80 m²/g; and in another aspect, the treated inorganic particles have a BET surface area of about 5-50 m²/g. The BET surface area may be measured by a surface area analyzer, such as Micromeritics TriStar II Plus, using the nitrogen adsorption method.

Inorganic particles include natural or synthetic materials or minerals. They typically have a high melting point, for example, above 200° C. Types of inorganic particles include, but are not limited to, inorganic oxide; inorganic carbide, such as silicon carbide; inorganic nitride, such as silicon nitride, aluminum nitride, or boron nitride; inorganic boride, such as titanium boride; inorganic silicide, such as molybdenum silicide; inorganic sulfate, such as aluminum sulfate or barium sulfate; inorganic carbonate, such as calcium carbonate or magnesium carbonate; inorganic silicates, such as aluminum silicate or magnesium silicate; or mixtures thereof. Inorganic oxides include but are not limited to metallic oxides, such as oxides of Ti, Al, Si, Zn, Sr, Ba, Pb, Ce, Zr, Sn, or mixtures thereof. Specific examples of inorganic oxides include TiO₂, Al₂O₃, SiO₂, ZnO, SrTiO₃, BaTiO₃, Ce₂O₃, ZrO₂, or mixtures thereof. Mixtures of inorganic compounds listed above may be present in the formation of the particle; for example, they may be part of the same particle core. Mixtures of inorganic particles of different inorganic compounds may also be physically blended and used. In one aspect, the inorganic particle comprises at least two inorganic compounds.

In one aspect, the inorganic particle is a titanium dioxide particle. The TiO₂ particle may be in rutile or anatase crystalline form, and it may be made by either a chloride process or sulfate process. In the chloride process, TiCl₄ is oxidized to TiO₂ particles. In the sulfate process, sulfuric acid and ore containing titanium are dissolved, and the resulting solution goes through a series of steps to yield TiO₂. Both the sulfate and chloride processes are described in greater detail in “The Pigment Handbook”, Vol. 1, 2nd Ed., John Wiley & Sons, NY (1988).

In another aspect, the inorganic particles may have one or more inorganic layers selected from the inorganic materials noted above. These inorganic layers are between the inorganic particle and the organic treatment layer and may be composed of the same or different inorganic compounds compared with the inorganic particle composition. For example, the inorganic particle may have a titanium dioxide core and one or more additional inorganic oxide layers. Such layers may be adsorbed onto the surface of the inorganic particle, or they may be chemically bonded to the surface of the inorganic particle by chemical reaction. In one aspect, the inorganic layer is applied by wet treatment process, from an aqueous basic or acidic metal salt compound. This method is described in U.S. Pat. No. 5,993,533. Another method of adding an inorganic layer is by deposition of pyrogenic inorganic compounds onto a pyrogenic titanium dioxide particle as described in U.S. Pat. No. 5,922,120. The inorganic layers may be continuous or discontinuous layers on the surface of the inorganic particle. Mixtures of inorganic compounds listed above may be present in each of the inorganic layers.

In one aspect, the inorganic particle further comprises at least one inorganic layer between the inorganic particle and the organic treatment layer; in another aspect, the inorganic particle further comprises at least two inorganic layers between the inorganic particle and the organic treatment layer. Such inorganic layers may be, for example, inorganic oxides, inorganic hydroxides, inorganic carbonates, or mixtures thereof. In one aspect, the inorganic layer or layers are metal oxides, metal hydroxides, or metal carbonates. In one aspect, the inorganic particle comprises at least two inorganic compounds and the treated inorganic particle further comprises at least one inorganic layer, where the at least one inorganic layer is between the inorganic particle and the organic treatment layer. As stated above, inorganic oxides include but are not limited to metallic oxides, such as oxides of Ti, Al, Si, Zn, Sr, Ba, Pb, Ce, Zr, Sn, or mixtures thereof. Specific examples of inorganic oxides include TiO₂, Al₂O₃, SiO₂, ZnO, SrTiO₃, BaTiO₃, Ce₂O₃, ZrO₂, or mixtures thereof. Oxides of P, such as P₂O₃ or P₂O₅; oxides of B such as B₂O₅; oxides of Ca such as CaO; or oxides of Mg such as MgO may also be incorporated. Other specific inorganic layers, including but not limited to Mg(OH)₂, Ca(OH)₂, CaCO₃, or MgCO₃, may also be used.

In one aspect, the inorganic particle is a TiO₂ particle, and the treated inorganic particle comprises at least one additional metal oxide selected from TiO₂, Al₂O₃, SiO₂, ZnO, SrTiO₃, BaTiO₃, Ce₂O₃, ZrO₂, or mixtures thereof. In one aspect, the at least one additional metal oxide is present in an amount of about 0.1-20% by weight; in another aspect, the at least one additional metal oxide is present in an amount of about 0.1-7% by weight; and in another aspect, the at least one additional metal oxide is present in an amount of about 0.5-7% by weight; based on the total weight of the treated inorganic particle. The at least one additional metal oxide may be part of the inorganic particle, or it may present in one or more inorganic layers. The inorganic particle may be made by co-oxygenation of inorganic tetrachloride with titanium tetrachloride, as described in U.S. Pat. Nos. 5,562,764, and 7,029,648. Examples of suitable commercially available titanium dioxide particles having at least one additional metal oxide include alumina-coated titanium dioxide particles such as Ti-Pure™ R700 and Ti-Pure™ R706, alumina/phosphate coated titanium-dioxide particles such as Ti-Pure™ R796+; and alumina/phosphate/ceria coated titanium-dioxide particles such as Ti-Pure™ R794; all available from The Chemours Company, Wilmington DE.

The treated inorganic particle contains an outermost layer of an organic treatment made up of an organic salt compound. The organic treatment layer is selected from an alkali metal salt or alkaline earth metal salt of an acid, where the acid is an aromatic acid or organic diacid. Mixtures of one or more types of these compounds may also be used. Some acid salt compounds making up the organic treatment layer may be in the form of a phosphate, sulfonate, sulfate, carbonate, or carboxylate compound. Examples of aromatic acids include but are not limited to aromatic monoacids such as benzoic acid. Organic diacids include but are not limited to C2-C18 straight or branched alkylene diacids such as oxalic acid (ethanedioic acid), malonic acid (propanedioic acid), succinic acid (butanedioic acid), glutaric acid (pentanedioic acid), adipic acid (hexanedioic acid), pimelic acid (heptanedioic acid), suberic acid (octanedioic acid), azelaic acid (nonanedioic acid), sebacic acid (decanedioic acid), undecanedioic acid, dodecanedioic acid, tridecanedioic acid, or hexadecanedioic acid. Corresponding phosphoric acids and sulfonic acids of any of the above carboxylic acid species are also encompassed. For example, ethanedisulfonic acid and ethanediphosphonic acid are encompassed by mention above of ethanedioic acid.

Specific organic treatment compounds include but are not limited to lithium benzoate, sodium benzoate, calcium benzoate, potassium benzoate, magnesium benzoate, zinc benzoate, lithium oxalate, sodium oxalate, calcium oxalate, potassium oxalate, magnesium oxalate, zinc oxalate, lithium malonate, sodium malonate, calcium malonate, potassium malonate, magnesium malonate, zinc malonate, lithium succinate, sodium succinate, calcium succinate, potassium succinate, magnesium succinate, zinc succinate, lithium glutarate, sodium glutarate, calcium glutarate, potassium glutarate, magnesium glutarate, zinc glutarate, lithium adipate, sodium adipate, calcium adipate, potassium adipate, magnesium adipate, zinc adipate, lithium pimelate, sodium pimelate, calcium pimelate, potassium pimelate, magnesium pimelate, or zinc pimelate.

The organic treatment layer may be applied to the inorganic particle by conventional means, such as by mixing the inorganic particle with the organic treatment compound in either solution or solid form, followed by drying and milling of the particles. In one embodiment, the organic treatment layer is present in an amount of about 0.1-15% by weight; in another aspect, the organic treatment layer is present in an amount of about 0.1-10% by weight; and in another aspect, the organic treatment layer is present in an amount of about 1-5% by weight; all based on the total weight of the treated inorganic pigment. In one aspect, the organic treatment layer comprises at least 80% by weight; in another aspect, at least 90% by weight; and in another aspect, at least 95% by weight of the organic salt compounds listed above; all based on the total weight of the individual organic treatment layer. There may be one or more organic treatment layers present in the treated inorganic particle, formed from the same or different organic salt compounds. In one aspect, the treated inorganic particle further comprises a second organic treatment layer. This second organic treatment layer may be beneath or above the organic treatment layer, as long as one organic treatment layer is present as the outermost layer of the treated inorganic particle.

The second organic treatment layer or any additional organic treatment layers may be selected from the organic salts noted above, or it may be selected from other organic compounds. Alternatively, a second organic compound may be present in the same layer as the organic treatment layer. Additional organic compounds suitable for use in the treated inorganic particle include but are not limited to hydrophobic compounds such as polyols, organosiloxanes, organosilanes, alkylcarboxylic acids, alkylsulfonates, organophosphates, organophosphonates, fluoropolymers, fluorosurfactants, and mixtures thereof. Such compounds may have at least one or more nonhydrolyzable aliphatic, cycloalipatic, fluorocarbon or aromatic groups having 6-20 carbon atoms. Examples include organosilanes having the formula:

R′ₓSi(R¹)₄₋ₓ

polysiloxanes having the formula:

$${( {R}_{n}^{2} {SiO}_{\frac{4 - n}{2}} )}_{m}$$

wherein R′ is a nonhydrolyzable aliphatic, cycloaliphatic, fluorocarbon or aromatic group having 1-20 carbon atoms; R¹ is a hydrolyzable group selected from alkoxy, halogen, acetoxy, hydroxy, or mixtures thereof; x=1 to 3; R² is an organic or inorganic group; n=0-3; and m≥2. Specific examples include but are not limited to octyltriethoxysilane, nonyltriethoxysilane, decyltriethoxysilane, dodecyltriethoxysilane, decyltriethoxysilane, tetradecyltriethoxysilane, pentadecyltriethoxysilane, hexadecyltriethoxysilane, heptadecyltriethoxysilane, octadecylmethoxysilane, polydimethylsiloxane, butyltrimethoxysilane, trichloro(octyl) silane, trimethoxy (3,3,3-trifluoropropyl) silane, trichloro(1H,1H,2H,2H-perfluorooctyl) silane, and 1H,1H,2H,2H-perfluorooctyltriethoxysilane, or trimethylolpropane.

The treated inorganic particles may be used to accelerate crystallization of crystalline polymers. Thus, the present invention further relates to a polymer composition comprising a polymer and a treated inorganic particle, where the treated inorganic particle comprises an inorganic particle having a surface and an organic treatment layer on the inorganic particle surface, where the inorganic particle has a mean particle size of about 0.1-10 μm and where the organic treatment layer is selected from alkali metal salt or alkaline earth metal salt of an acid; where the acid is an aromatic acid or organic diacid; and where the polymer is polypropylene homopolymer or copolymer, polyethylene homopolymer or copolymer, polyester, or mixtures thereof. The polymer includes melt-processable polymers having a high molecular weight, preferably thermoplastic resin. The term “high molecular weight” is meant to describe polymers having a melt index value of about 0.01 to about 100, as measured by ASTM method D1238-98. In one aspect, the polymer has a melt index of about 0.01 to about 100; in another aspect, about 0.01 to about 50; in another aspect, about 1 to about 50, and in another aspect, about 2 to about 10, all as measured by ASTM method D1238-98. By “melt-processable,” it is meant a polymer must be melted (or be in a molten state) before it can be extruded or otherwise converted into shaped articles, including films and objects having from one to three dimensions. Also, it is meant that a polymer can be repeatedly manipulated in a processing step that involves obtaining the polymer in the molten state.

Polymers that are suitable for use in this invention include but are not limited to polyolefins such as polyethylene homopolymers or copolymers, polypropylene homopolymers or copolymers; polyesters; or mixtures thereof. Specific polyethylene polymers include but are not limited to high-density polyethylene, medium-density polyethylene, linear-low-density polyethylene and low-density polyethylene. Specific polypropylene homopolymers include but are not limited to atactic polypropylene homopolymer, isotactic polypropylene homopolymer, and syndiotactic polypropylene homopolymer. In one aspect, a polypropylene polymer may have 98-100% by weight propylene units and may be isotactic polypropylene such as, for example, HIPP (highly isotactic polypropylene) or HCPP (highly crystalline polypropylene). The polypropylene polymer may have 96-99% chain isotacticity; or in another aspect, 97-99% chain isotacticity; all by 13C NMR, triad method. Polyesters may include, for example, poly(ethylene terephthalate) or other common polyesters.

When polyethylene or polypropylene copolymers are used, the polymer is typically a copolymer of polyethylene or polypropylene with an α-olefin comonomer. In one aspect, the polyethylene or polypropylene copolymer contains about 70-99% by weight of polyethylene or polypropylene and about 1-30% by weight of an α-olefin comonomer; in another aspect, the polyethylene or polypropylene copolymer contains about 75-99% by weight of polyethylene or polypropylene and about 1-25% by weight of an α-olefin comonomer; and in another aspect, the polyethylene or polypropylene copolymer contains about 80-99% by weight of polyethylene or polypropylene and about 1-20% by weight of an α-olefin comonomer; all based on the total copolymer weight.

Suitable polyethylene copolymers include copolymers of ethylene with one or more α-olefins including but not limited to 1-buene, 1-hexene, 1-octene, 4-methyl-1-pentene, vinyl acetate, methyl acrylate, ethyl acrylate, acrylic acid, or mixtures thereof. These comonomers can be present in any suitable amount, with typical comonomer content ranging from 1% by weight to 20% by weight, based on the total copolymer weight. The amount of comonomer necessary is driven by the end use of the polymer and the desired polymer properties for that end use.

Polypropylene copolymers include random copolymers of propylene and a comonomer such as ethylene, 1-butene, 1-hexene, or mixtures thereof. Other suitable polypropylene copolymers include impact copolymers produced by the addition of a copolymer such as ethylene-propylene rubber (EPR), ethylene-propylene-diene monomer (EPDM), polyethylene, or plastomers to a polypropylene homopolymer or polypropylene random copolymer. In polypropylene random copolymers, the comonomer can be present in any suitable amount, but typically is present in an amount of less than about 10% by weight, based on the total copolymer weight. In one aspect, the comonomer is present at about 1-7% by weight, based on the total copolymer weight. In typical polypropylene impact copolymers, the comonomer can be present in any suitable amount, but typically is present in an amount of from about 5-25% by weight, based on the total copolymer weight.

A wide variety of additives may be present in the packaging composition of this invention as necessary, desirable, or conventional. Such additives include polymer processing aids (e.g., fluoropolymers, fluoroelastomers, etc.), catalysts, initiators, antioxidants (e.g., hindered phenol such as butylated hydroxytoluene), blowing agents, stabilizers (e.g., hydrolytic stabilizers, radiation stabilizers, thermal stabilizers, or ultraviolet light stabilizers such as hindered amine light stabilizers or “HALS”), ultraviolet ray absorbers, organic pigments including tinctorial pigments, plasticizers, antiblocking agents (e.g. clay, talc, calcium carbonate, silica, silicone oil, and the like), anti-static agents, leveling agents, flame retardants, anti-cratering additives, optical brighteners, adhesion promoters, colorants, dyes or pigments, delustrants, fillers, fire retardants, lubricants, reinforcing agents (e.g., glass fiber and flakes), anti-slip agents, slip agents (e.g., talc or anti-block agents), and other additives.

Any melt compounding techniques known to those skilled in the art may be used to process the compositions of the present invention. Packages or other articles may be made after the formation of a masterbatch. The term masterbatch is used herein to describe a mixture of inorganic particles and/or fillers (including TiO₂ particles) (collectively called solids), melt processed at high solids to resin loadings (generally 50-70 wt % by weight of the total masterbatch) in high shear compounding machinery such as Banbury mixers, continuous mixers or twin screw mixers, which are capable of providing enough shear to fully incorporate and disperse the solids into the melt processable resin. The resultant melt processable resin product highly loaded with solids is termed a masterbatch, and is typically subsequently diluted or “letdown” by incorporation of additional virgin melt processable resin in plastic production processes. The letdown procedure is accomplished in the desired processing machinery utilized to make the final consumer article, whether it is sheet, film, bottle, package or another shape. The amount of virgin resin utilized and the final solids content is determined by the use specifications of the final consumer article. The masterbatch composition of this invention is useful in the production of shaped articles.

When forming a masterbatch formulation, the polymer composition generally comprises about 20-99.9% by weight of the polymer and about 0.1-80% by weight of the treated inorganic particle; in another aspect, about 30-99.9% by weight of the polymer and about 0.1-70% by weight of the treated inorganic particle; in another aspect, about 50-99% by weight of the polymer and about 1-50% by weight of the treated inorganic particle; all based on the total polymer composition. In final formulations that will be used for the end use, the polymer composition generally comprises about 50-99.9% by weight of the polymer and about 0.1-50% of the treated inorganic particle; in another aspect, about 60-99.9% by weight of the polymer and about 0.1-40% by weight of the treated inorganic particle; and in another aspect, about 70-99.5% by weight of the polymer and 0.5-30% by weight of the treated inorganic particle; all based on the total polymer composition.

### EXAMPLES

All solvents and reagents, unless otherwise indicated, were purchased from Millipore Sigma, St. Louis, MO, and used directly as supplied. High density polyethylene (HDPE) had a melt index of 12 g/10 minutes at 190° C./2.16 kg and is available from Millipore Sigma, St. Louis, MO.

The isotactic polypropylene (iPP) used was Profax™ 6331, and the polypropoylene (PP) impact copolymer used was a polyethylene-polypropylene copolymer Profax™ SB786; both available from LyondellBasell, Newtown Square, PA.

The poly(ethylene terephthalate) (PET) used was Arnite A02 307, available from DSM, Heerlen, Netherlands.

Ti-Pure™ R-101 is a rutile plastics-grade TiO₂ pigment having at most 1.7% by weight alumina content and having 0.2% by weight of an organic treatment, based on the weight of the pigment, with a mean particle size of 0.29 μm and a BET surface area of 7-8 m²/g. Ti-Pure™ R-104 is a rutile plastics-grade TiO₂ pigment having at most 1.7% by weight alumina content and having 0.3% by weight of an organic treatment, based on the weight of the pigment, with a mean particle size of 0.29 μm with a BET surface area of 7-8 m²/g. Both pigments are available from The Chemours Company, Wilmington, DE.

The following test methods and materials were used in the examples herein.

### Test Methods

### Test Method 1-Differential Scanning Calorimetry (DSC)

DSC experiments were performed on a Mettler Toledo DSC 3 under nitrogen atmosphere. The samples were heated from 25° C. to a set temperature according to Table 1 at a rate of 10° C. per minute and maintained at temperature for 5 minutes. The samples were then cooled to 25° C. at a cooling rate of 10° C. per minute and maintained at temperature for 5 minutes. The samples were then reheated to the set temperature at a rate of 10° C. per minute.

TABLE 1
Set Temperature for Various Polymers

| Polymer | Set Temperature (° C.) |
|---|---|
| iPP | 200 |
| HDPE | 150 |
| PET | 300 |
| PP impact copolymer | 200 |

Crystallization temperature (T_{c}) and kinetic parameters (Z_{c} and t_{1/2}) were obtained from the cooling curve after the first heat. The two parameters are used to describe the kinetics of crystallization process. The larger the Z_{c} (or the smaller the t_{1/2}), the faster the crystallization. Z_{c} is a non-isothermal crystallization rate constant and can be calculated from the DSC data using the equation below:

$$log {Z}_{c} = \frac{log {Z}_{t}}{dT / dt} \qquad ( 1 )$$

where dT/dt is the DSC cooling rate in K/min and Zₜ is the kinetic parameter occurring in the Avrami equation for polymers: [1-X]=exp[−Zₜtⁿ], where t is time and n is the unitless Avrami exponent that is the slope of the plot of

$$log [ - ln ( 1 - X ) ] = n log t + log {Z}_{t} \qquad ( 2 )$$

X is the ratio of:

$$\frac{degree of crystallinity after time t}{maximum degree of crystallinity} \qquad ( 3 )$$

as a result of crystallization, as recorded by DSC. The Avrami equation and Avrami exponent are further described in Jesiorny, “Parameters characterizing the kinetics of the non-isothermal crystallization of poly(ethylene terephthalate) determined by d.s.c.”, Polymer (1978), 19:1142-1144.

### Test Method 2-Surface Area

Analyses for particle surface area were performed at 77.3 K on dry pigment powders using a Micromeritics TriStar II Plus surface area and porosity analyzer. Surface area measurements utilized a five-point adsorption isotherm collected over 0.05 to 0.20 p/p₀ and analyzed via the BET method.

### Test Method 3-Mean Particle Size

Analyses for median particle size were performed on sonicated 3 wt % solids slurries (made up in a 0.2 g/L tetrapotassium pyrophosphate solution) using a Horiba LA-900 laser light-scattering particle size analyzer (Horiba Instruments, Inc., Irvine, Calif.). The sonicator was a Sonicator Ultrasonic Liquid Processor Model XL 2020, Heat Systems, Inc., Farmingdale, N.Y.

### Preparation of Sodium Adipate

Distilled water (50 mL) was heated to 85° C. while stirring with pH probe present. NaOH pellets (8 g) were added to the heated water. After the pellets dissolved, adipic acid (14.7 g) was added to the heated solution. Before the solution could cool, the pigment surface was treated with the resulting bis-sodium adipate solution.

### Comparative Example A

T_{c} of neat iPP resin was measured according to the test method above and found to be 113.15° C.

### Comparative Example B

Melt mixings were completed using the Xplore MC 15 HT microcompounder, with the barrel temperature was set at 190° C. and the screw speed set to 100 rpm. iPP pellets were slowly added into the barrel followed by the addition of Ti-Pure™ R-101 TiO₂ particles at the loading amount specified in Table 3, based on the total weight of the resin mixture. The mixture was allowed to mix for 2 min before being extruded and collected. T_{c} was measured according to the test method above.

### Comparative Example C

Comparative Example B was repeated, using Ti-Pure™ R-104.

### Examples 1-12

TiO₂ particles were obtained having the surface alumina and silica amounts shown in Table 2. Aqueous solutions of salt compounds were directly sprayed onto TiO₂ particles to achieve the amounts shown in Table 2. Percentages are by weight based on the total particle weight. After the water has been completely dried, the particles were deagglomerated via a milling process. Surface area and mean particle size were determined by the Test Methods above.

Melt mixings were completed using the Xplore MC 15 HT microcompounder, with the barrel temperature was set at 190° C. and the screw speed set to 100 rpm. iPP resin was slowly added into the barrel followed by the addition of TiO₂ particles at the loading amount specified in Table 3, based on the total weight of the resin mixture. The mixture was allowed to mix for 2 min before being extruded and collected. T_{c} was measured according to the test method above.

TABLE 2
Composition of Examples 1-12

| | Surface | Surface | | | Mean |
|---|---|---|---|---|---|
| | alumina | Silica | Organic Treatment | Surface | Particle |
| | (% by | (% by | Compound/% by | Area | Size |
| Example | weight) | weight) | weight | (m²/g) | (μm) |
| 1 | 1.2 | 0 | Sodium adipate/5 | 7.33 | 0.2-0.3 |
| 2 | 3.7 | 0 | Sodium adipate/5 | 7.92 | 0.2-0.3 |
| 3 | 21.2 | 0 | Sodium adipate/5 | 16.39 | 0.2-0.3 |
| 4 | 4.2 | 11 | Sodium adipate/5 | 29.44 | 0.2-0.3 |
| 5 | 1.2 | 0 | Sodium benzoate/5 | 7.09 | 0.2-0.3 |
| 6 | 3.7 | 0 | Sodium benzoate/5 | 7.7 | 0.2-0.3 |
| 7 | 21.2 | 0 | Sodium benzoate/5 | 19.46 | 0.2-0.3 |
| 8 | 4.2 | 11 | Sodium benzoate/5 | 39.64 | 0.2-0.3 |
| 9 | 3 | 3 | Sodium benzoate/1 | 12.36 | 0.2-0.3 |
| 10 | 3 | 3 | Sodium benzoate/4 | 11.41 | 0.2-0.3 |
| 11 | 1.2 | 3 | Sodium benzoate/1 | 7.56 | 0.2-0.3 |
| 12 | 1.2 | 3 | Sodium benzoate/4 | 7.46 | 0.2-0.3 |

TABLE 3
Performance of Examples 1-12 and Comparative Examples
Comparative Example A-Comparative Example C

| | Particle loading (% by weight) | | | |
|---|---|---|---|---|
| | 1 | 2 | 4 | 8 |
| Example | T_{c} (° C.) | T_{c} (° C.) | T_{c} (° C.) | T_{c} (° C.) |
| 1 | 120.25 | 120.88 | 122.59 | 124.57 |
| 2 | 118.77 | 120.26 | 121.51 | 122.18 |
| 3 | 119.57 | 120.27 | 121.85 | 122.32 |
| 4 | 123.31 | 124.19 | 125.12 | 125.93 |
| 5 | 120.33 | 123.27 | 127.4 | 131.02 |
| 6 | 120.48 | 123.74 | 128.71 | 131.53 |
| 7 | 121.44 | 126.98 | 130 | 132.82 |
| 8 | 122.38 | 125.59 | 129.42 | 130.39 |
| 9 | 119.29 | 120.76 | 122.07 | 123.12 |
| 10 | 118.70 | 121.82 | 126.76 | 130.33 |
| 11 | 119.52 | 120.35 | 122.22 | 123.26 |
| 12 | 119.57 | 121.81 | 126.53 | 129.56 |
| Comparative Example B | 113.60 | 114.37 | 115.26 | 117.13 |
| Comparative Example C | 113.96 | 115.32 | 116.14 | 117.43 |

Examples including inorganic pigments exhibited higher T_{c} values compared with neat iPP when used at higher loadings. However, examples including the treated inorganic particles of the present invention exhibited superior T_{c} values compared with both neat iPP and iPP including inorganic particles.

### Comparative Example D

This example represents a physical blending of salt compound with inorganic particles in the resin melt. Comparative Example C was repeated, adding dry sodium benzoate directly into the resin with the TiO₂ particles. The amounts of sodium benzoate used directly correlate to the amount present in Example 5 above. Amounts are based on the total weight of the resin mixture.

TABLE 4
Composition and Performance of Comparative Example D

| Particle loading (% by weight) | 1 | 2 | 4 | 8 |
|---|---|---|---|---|
| Sodium benzoate loading (% by | 0.05 | 0.1 | 0.2 | 0.4 |
| weight) | | | | |
| T_{c} (° C.) | 117.23 | 118.93 | 120.42 | 123.79 |

When the results are compared with those of Example 5, it can be seen that the inorganic particles having organic salt surface treatments have a noticeable and unexpectedly higher T_{c} when compared with inorganic particles that are merely blended with the organic salt and resin material.

### Comparative Example E

T_{c} of neat HDPE resin was measured according to the test method above and found to be 116.36° C. Kinetic parameters were found to be: Z_{c}=1.367 and t_{1/2} (min)=0.395.

### Comparative Example F

Comparative Example C was repeated, using HDPE instead of iPP. Melt mixings were completed using the Xplore MC 15 HT microcompounder, with the barrel temperature was set at 170° C. and the screw speed set to 100 rpm. T_{c} and kinetic parameters were measured according to the test method above.

### Example 13

Example 6 was repeated and compounded into HDPE instead of iPP. Melt mixings were completed using the Xplore MC 15 HT microcompounder, with the barrel temperature was set at 170° C. and the screw speed set to 100 rpm. T_{c} and kinetic parameters were measured according to the test method above.

TABLE 5
Performance of Examples 13 and Comparative Example F

| | | | Comparative | |
|---|---|---|---|---|
| | | Example | Example F | 13 |
| Particle loading | 1 | T_{c} (° C.) | 116.25 | 116.37 |
| (% by weight) | | Z_{c} | 1.193 | 1.385 |
| | | t_{1/2} (min) | 0.578 | 0.396 |
| | 2 | T_{c} (° C.) | 116.34 | 116.61 |
| | | Z_{c} | 1.145 | 1.301 |
| | | t_{1/2} (min) | 0.607 | 0.413 |
| | 4 | T_{c} (° C.) | 116.95 | 117.16 |
| | | Z_{c} | 1.157 | 1.251 |
| | | t_{1/2} (min) | 0.614 | 0.45 |

In HDPE matrix, the T_{c} is similar when comparing neat HDPE, HDPE containing traditional inorganic particles, and inorganic particles of the present invention. However, it is important to note that the kinetics were improved by the addition of the present organic-treated inorganic particles. Z_{c} increased and t_{1/2} decreased at all loading levels, indicating faster crystallization rates and lower processing time. The crystallization of HDPE will retard with the addition of TiO₂, but the inorganic particles of the present invention provide the benefits of an inorganic particle while allowing the resin to crystallize at rates close to or equivalent to neat HDPE.

### Comparative Example G

T_{c} of neat PET resin was measured according to the test method above and found to be 205.31° C.

### Comparative Example H

Comparative Example C was repeated, using PET instead of iPP. Melt mixings were completed using the Xplore MC 15 HT microcompounder, with the barrel temperature set at 275° C. and the screw speed set to 50 rpm.

### Example 14

Example 6 was repeated and compounded into PET instead of iPP. Melt mixings were completed using the Xplore MC 15 HT microcompounder, with the barrel temperature set at 275° C. and the screw speed set to 50 rpm.

TABLE 6
Performance of Example 14 and Comparative Example H

Particle loading (% by weight)

| | 1 | 2 | 4 |
|---|---|---|---|
| Example | T_{c} (° C.) | T_{c} (° C.) | T_{c} (° C.) |
| Comparative Example H | 208.67 | 206.64 | 206.77 |
| 14 | 214.04 | 215.54 | 218.96 |

Examples including inorganic pigments exhibited higher T_{c} values compared with neat PET, though at higher loadings the T_{c} value was reduced. However, examples including the treated inorganic particles of the present invention exhibited superior T_{c} values compared with both neat PET and PET including inorganic particles. Additionally, no reduction of T_{c} was observed at higher particle loadings.

### Comparative Example I

T_{c}1 (polypropylene phase crystallization) and T_{c}2 (polyethylene phase crystallization) of neat PP copolymer resin were measured according to the test method above and found to be: 112.85° C. (T_{c}1) and 104.08° C. (T_{c}2).

### Comparative Example J

Comparative Example C was repeated, using PP impact copolymer instead of iPP.

### Example 15

Example 6 was repeated and compounded into PP impact copolymer instead of iPP.

TABLE 7
Performance of Example 15 and Comparative Example J

| | | Example | J | 15 |
|---|---|---|---|---|
| Particle loading | 1 | T_{c1} (° C.) | 117.51 | 121.19 |
| (% by weight) | | T_{c2} (° C.) | 106.42 | 106.62 |
| | 2 | T_{c1} (° C.) | 117.53 | 123.39 |
| | | T_{c2} (° C.) | 106.26 | 107.12 |
| | 4 | T_{c1} (° C.) | 118.24 | 125.98 |
| | | T_{c2} (° C.) | 106.28 | 106.64 |
| | 8 | T_{c1} (° C.) | 121.28 | 131.18 |
| | | T_{c2} (° C.) | 106.62 | 107.31 |

Examples including inorganic pigments exhibited higher T_{c} values at both polyethylene and polypropylene phases when compared with neat PP impace copolymer. However, examples including the treated inorganic particles of the present invention exhibited superior T_{c} values compared with both neat PP impact copolymer and the PP impact copolymer example including inorganic particles.

1. A treated inorganic particle comprising an inorganic particle having a surface and an organic treatment layer on the inorganic particle surface,
where the treated inorganic particle has a mean particle size of about 0.1-10 μm and
where the organic treatment layer is selected from alkali metal salt or alkaline earth metal salt of an acid; where the acid is an aromatic acid or organic diacid.

2. The treated inorganic particle of claim 1, where the inorganic particle is an inorganic oxide, inorganic carbide, inorganic nitride, inorganic boride, inorganic silicide, inorganic sulphate, inorganic carbonate, inorganic silicates, or mixtures thereof.

3. The treated inorganic particle of claim 1, where the mean particle size is about 0.1-1 μm.

4. The treated inorganic particle of claim 1, where the acid is an aromatic monoacid or C2-C18 straight or branched alkylene diacid.

5. The treated inorganic particle of claim 1, where the alkali metal salt or alkaline earth metal salt is a phosphate, sulfonate, sulfate, carbonate, or carboxylate compound.

6. The treated inorganic particle of claim 1, having a BET surface area of about 1-100 m²/g.

7. The treated inorganic particle of claim 1, further comprising at least one metal oxide, metal hydroxide, or metal carbonate layer between the inorganic particle and the organic treatment layer.

8. The treated inorganic particle of claim 1, further comprising a second organic treatment layer beneath or above the organic treatment layer.

9. The treated inorganic particle of claim 2, where the inorganic particle is an inorganic oxide selected from TiO₂, Al₂O₃, SiO₂, ZnO, SrTiO₃, BaSO₄, PbCO₃, BaTiO₃, Ce₂O₃, CaCO₃, or ZrO₂.

10. The treated inorganic particle of claim 1, where the organic treatment layer is present in an amount of about 0.1-15% by weight, based on the total weight of the treated inorganic particle.

11. A polymer composition comprising a polymer and a treated inorganic particle,
where the treated inorganic particle comprises an inorganic particle having a surface and an organic treatment layer on the inorganic particle surface, where the inorganic particle has a mean particle size of about 0.1-10 μm and where the organic treatment layer is selected from alkali metal salt or alkaline earth metal salt of an acid;
where the acid is an aromatic acid or organic diacid; and
where the polymer is polypropylene homopolymer or copolymer, polyethylene homopolymer or copolymer, polyester, or mixtures thereof.

12. The polymer composition of claim 11, where the inorganic particle is an inorganic oxide, inorganic carbide, inorganic nitride, inorganic boride, inorganic silicide, inorganic sulphate, inorganic carbonate, inorganic silicates, or mixtures thereof.

13. The polymer composition of claim 11, where the mean particle size is about 0.1-1 μm.

14. The polymer composition of claim 11, where the acid is an aromatic monoacid or C2-C18 straight or branched alkylene diacid.

15. The polymer composition of claim 11, where the alkali metal salt or alkaline earth metal salt is a phosphate, sulfonate, sulfate, carbonate, or carboxylate compound.

16. The polymer composition of claim 11, where the treated inorganic particle has a BET surface area of about 1-100 m²/g.

17. The polymer composition of claim 11, where the treated inorganic particle further comprises at least one metal oxide, metal hydroxide, or metal carbonate layer between the inorganic particle and the organic treatment layer.

18. The polymer composition of claim 11, where the treated inorganic particle further comprises a second organic treatment layer beneath or above the organic treatment layer.

19. The polymer composition of claim 12, where the inorganic particle is an inorganic oxide selected from TiO₂, Al₂O₃, SiO₂, ZnO, SrTiO₃, BaSO₄, PbCO₃, BaTiO₃, Ce₂O₃, CaCO₃, or ZrO₂.

20. The polymer composition of claim 11, where the organic treatment layer is present in an amount of about 0.1-15% by weight, based on the total weight of the treated (Currently amended) inorganic particle.

21. The polymer composition of claim 11, comprising about 20-99.9% by weight of the polymer and about 0.1-80% by weight of the treated inorganic particle, based on the total polymer composition.
